(19) United States
(12) Patent Application Publication
(10) Pub. No.: US 2026/0281880 A1
(43) Pub. Date: Sep. 17, 2026

(54) METHOD AND DEVICE FOR PERFORMING WI-FI AWARE COMMUNICATION

(71) Applicant: Samsung Electronics Co., Ltd., Suwon-si, Gyeonggi-do (KR)

(72) Inventors: Hyunseob OH, Suwon-si (KR); Junsung KIM, Suwon-si (KR); Seungbeom SEO, Suwon-si (KR); Buseop JUNG, Suwon-si (KR); Junyoung CHOI, Suwon-si (KR); Sehee HAN, Suwon-si (KR)

(21) Appl. No.: 19/469,632

(22) PCT Filed: Mar. 29, 2024
(86) PCT No.: PCT/KR2024/004083

§ 371 Date: Sep. 26, 2025

(30) Foreign Application Priority Data
Mar. 29, 2023 (KR) 10-2023-0041556

(51) Int. Cl. H04W 48/16; H04W 72/0453; H04W 72/1263; H04W 84/12

(52) U.S. Cl. CPC H04W 48/16; H04W 72/0453; H04W 72/1263; H04W 84/12

(57) ABSTRACT

A method for operating an electronic device for performing Wi-Fi Aware communication according to an embodiment of the present disclosure comprises the operations of: transmitting a Bluetooth low energy (BLE) advertisement message, and activating a Wi-Fi Aware module of the electronic device; identifying whether a real-time simultaneous dual-band (RSDB) function is available; as a result of the identification, when the RSDB function is available, selecting one RSDB scheduling option from among multiple RSDB scheduling options on the basis of an access point (AP) traffic characteristic and whether there is an AP connection of the electronic device; and performing a discovery procedure according to the selected RSDB scheduling option.

### CROSS-REFERENCE TO RELATED APPLICATION(S)

This application is a U.S. National Stage application under 35 U.S.C. § 371 of an International application number PCT/KR2024/004083, filed on Mar. 29, 2024, which is based on and claims priority of a Korean patent application number 10-2023-0041556, filed on Mar. 29, 2023, in the Korean Intellectual Property Office, the disclosure of which is incorporated by reference herein in its entirety.

### TECHNICAL FIELD

The disclosure relates to a method for Wi-Fi Aware communication between electronic devices.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment, intelligent Internet Technology (IT) services that collect and analyze data generated by connected things to create new value for human life may be provided. The IoT may be applied in various fields, such as smart homes, smart buildings, smart cities, smart or connected cars, smart grids, health care, smart appliances, and state-of-the-art medical services, through the convergence and integration of conventional Information Technology (IT) and various industries.

Wi-Fi CERTIFIED Wi-Fi Aware™ (Wi-Fi Aware) is a technology that extends the capabilities of Wi-Fi by enabling rapid discovery, connection, and data exchange with other Wi-Fi devices without the need for traditional network infrastructure, Internet connection, or GPS signals. Wi-Fi Aware may provide the function of enabling a mutual search and direct connection between devices even without any other type of connection. Wi-Fi Aware may also be referred to as neighbor awareness networking (NAN).

### DETAILED DESCRIPTION OF THE INVENTION

### Technical Problem

The disclosure proposes a method for managing wireless channel and time resources during Wi-Fi Aware communication.

### Technical Solution

According to an embodiment of the disclosure, a method of operating an electronic device performing Wi-Fi Aware communication includes transmitting a Bluetooth low energy (BLE) advertisement message and activating a Wi-Fi Aware module of the electronic device, identifying whether a real-time simultaneous dual band (RSDB) function is available, if the RSDB function is available as a result of the identifying, selecting one RSDB scheduling option from among a plurality of RSDB scheduling options based on whether there is an access point (AP) connection of the electronic device and AP traffic characteristics, and performing a discovery procedure according to the selected RSDB scheduling option.

According to an embodiment of the disclosure, an electronic device performing Wi-Fi Aware communication comprises a transceiver; and a controller. The controller may transmit a Bluetooth low energy (BLE) advertisement message and activate a Wi-Fi Aware module of the electronic device. The controller may identify whether a real-time simultaneous dual band (RSDB) function is available. The controller may, if the RSDB function is available as a result of the identifying, select one RSDB scheduling option from among a plurality of RSDB scheduling options based on whether there is an access point (AP) connection of the electronic device and AP traffic characteristics. The controller may perform a discovery procedure according to the selected RSDB scheduling option.

### Advantageous Effects

According to an embodiment of the disclosure, an electronic device may utilize enhanced wireless channel and time resources during Wi-Fi Aware communication.

According to an embodiment of the disclosure, an electronic device may enhance communication efficiency by adaptively selecting a scheduling method during Wi-Fi Aware communication.

### BRIEF DESCRIPTION OF DRAWINGS

FIG. 1 illustrates an example of device and service discovery of a Wi-Fi Aware device.

FIG. 2 illustrates an example of various nodes included in a cluster.

FIG. 3 is a view illustrating an unsynchronized service discovery (USD) operation of Wi-Fi Aware devices according to an embodiment of the disclosure.

FIG. 4 is a view illustrating a USD operation of Wi-Fi Aware devices according to another embodiment of the disclosure.

FIG. 5 is a view illustrating a USD operation of Wi-Fi Aware devices according to another embodiment of the disclosure.

FIG. 6 is a view illustrating a service discovery period (SDP) according to an embodiment of the disclosure.

FIG. 7 illustrates examples of channel and time resource operation according to whether real-time simultaneous dual band (RSDB) is operated according to an embodiment of the disclosure.

FIG. 8 illustrates examples of channel and time resource operation according to various conditions in an RSDB operable circumstance according to an embodiment of the disclosure.

FIG. 9 is a flowchart for describing an operation of an electronic device (sender) according to an embodiment of the disclosure.

FIG. 10 is a view illustrating a structure of an electronic device (sender) according to an embodiment of the disclosure.

FIG. 11 is a view illustrating a structure of an electronic device (receiver) according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present disclosure is omitted. This is for further clarifying the gist of the present disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present disclosure is not limited to the embodiments disclosed herein, and various changes may be made thereto. The embodiments disclosed herein are provided only to inform one of ordinary skilled in the art of the category of the present disclosure. The present disclosure is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Wi-Fi CERTIFIED Wi-Fi Aware™ (Wi-Fi Aware) is a technology that extends the capabilities of Wi-Fi by enabling rapid discovery, connection, and data exchange with other Wi-Fi devices without the need for traditional network infrastructure, Internet connection, or GPS signals. Wi-Fi Aware may provide the function of enabling a mutual search and direct connection between devices even without any other type of connection. Wi-Fi Aware may also be referred to as neighbor awareness networking (NAN).

Wi-Fi Aware networking may work by forming a cluster with a peripheral device or by creating a new cluster if the device is the first device in the area. An application may communicate with a Wi-Fi Aware system service that manages the device's Wi-Fi Aware hardware using a Wi-Fi Aware application programming interface (Wi-Fi Aware API). For example, a Wi-Fi Aware network connection may support higher processing speeds over long distances where Bluetooth connections are not reachable. For example, the Wi-Fi Aware network connection may be useful for apps that share large amounts of data between users, such as photo-sharing apps.

Bluetooth low energy (BLE) refers to a technology that operates at lower power than conventional Bluetooth (or Bluetooth classic) and may be used in electronic devices such as smart bands, watches, and beacons, for example.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

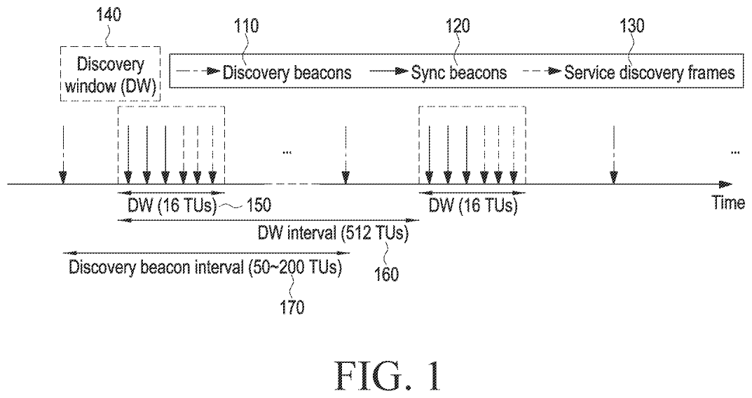

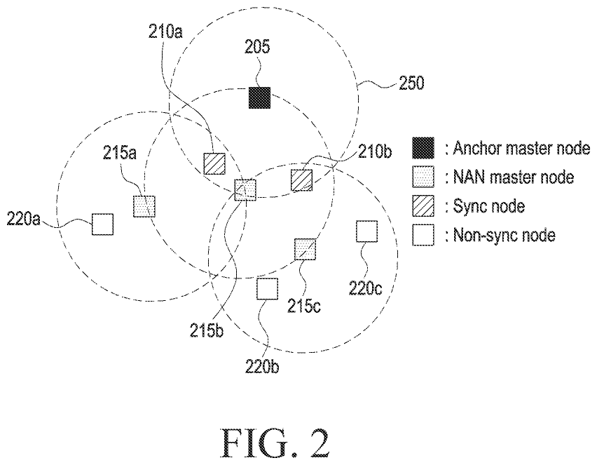

FIG. 1 and FIG. 2 show examples of legacy Wi-Fi operation and node configuration.

FIG. 1 illustrates an example of device and service discovery of a Wi-Fi Aware device.

Referring to FIG. 1, at least one electronic device included in a cluster may transmit at least one discovery beacon 110 according to the NAN specification. The at least one electronic device may transmit at least one synchronization beacon 120 and/or at least one service discovery frame 130 within a discovery window (DW) 140 that occupies 16 time units (TU) according to the NAN specification.

According to an embodiment, the DW 140 may occupy 16 TUs, and a DW interval 160, which is a time interval between DWs 140, may occupy 512 TUs. According to an embodiment, a discovery beacon interval 170 indicating a transmission interval of the at least one discovery beacon 110 may occupy 50 to 200 TUs. A time during which an electronic device performs discovery may be dependent on the DW interval 160.

According to an embodiment, the at least one synchronization beacon 120 may be a signal for maintaining synchronization (e.g., time clock synchronization) between electronic devices included in a cluster. The at least one synchronization beacon 120 may include at least one piece of information accompanying synchronization between electronic devices.

For example, the at least one synchronization beacon 120 may include at least one of a frame control (FC) field indicating a function (e.g., beacon) of a signal, a broadcast address, a media access control (MAC) address of an electronic device that transmitted the at least one synchronization beacon 120, a cluster identifier, a sequence control field, a time stamp for a beacon frame, a beacon interval field indicating an interval between start times of synchronized communication sections, or capability information of an electronic device that transmitted the at least one synchronization beacon 120.

The at least one synchronization beacon 120 may include at least one information element related to at least one proximity network, and may include, e.g., service-related content that may be provided based on a proximity network. According to the NAN specification, the at least one synchronization beacon 120 may be transmitted by an electronic device defined as an anchor master device, a master device, or a non-master sync device among at least one electronic device in a cluster.

According to an embodiment, the at least one service discovery frame 130 may be a signal for advertising a service between at least one electronic device in a cluster and exchanging information related to the service based on a proximity network. According to the NAN specification, the at least one service discovery frame 130 is a vendor specific public action frame and may include various fields. For example, the at least one service discovery frame 130 may include at least one information element related to at least one proximity network.

According to an embodiment, the at least one electronic device may transmit the at least one discovery beacon 110 within an interval other than a DW interval 140. The at least one discovery beacon 110 may be a signal of a cluster advertisement function transmitted so that at least one electronic device that has not joined a cluster may discover the cluster.

According to an embodiment, at least one electronic device that has not joined a cluster may perform a passive scan to detect the at least one discovery beacon 110 transmitted from at least one electronic device participating in a cluster, thereby discovering the cluster and joining the cluster.

According to an embodiment, the at least one discovery beacon 110 may include at least one piece of information for synchronizing to a cluster. According to an embodiment, the discovery beacon 110 may include at least one of a frame control (FC) field indicating a function (e.g., beacon) of a signal, a broadcast address, a media access control (MAC) address of an electronic device that transmitted the at least one discovery beacon 110, a cluster identifier, a sequence control field, a time stamp for a beacon frame, a discovery beacon interval field indicating a transmission interval of the at least one discovery beacon 110, or capability information of an electronic device that transmitted the at least one discovery beacon 110. According to an embodiment, the at least one discovery beacon 110 may include at least one information element related to at least one proximity network.

FIG. 2 illustrates an example of various nodes included in a cluster.

Each of the nodes illustrated in FIG. 2 may be implemented as an electronic device (or Wi-Fi Aware device). Referring to FIG. 2, each of the electronic devices may be classified as an anchor master node 205, NAN master nodes 215a, 215b, 215c, sync nodes 210a, 210b, or non-sync nodes 220a, 220b, 220c.

According to an embodiment, the anchor master node 205 may communicate with the sync nodes 210a, 210b and the NAN master node 215b within coverage through the discovery method of FIG. 1. According to an embodiment, the anchor master node 205 has constraints in direct communication with nodes positioned outside coverage and may communicate with nodes positioned outside coverage through hops via connections with other master nodes.

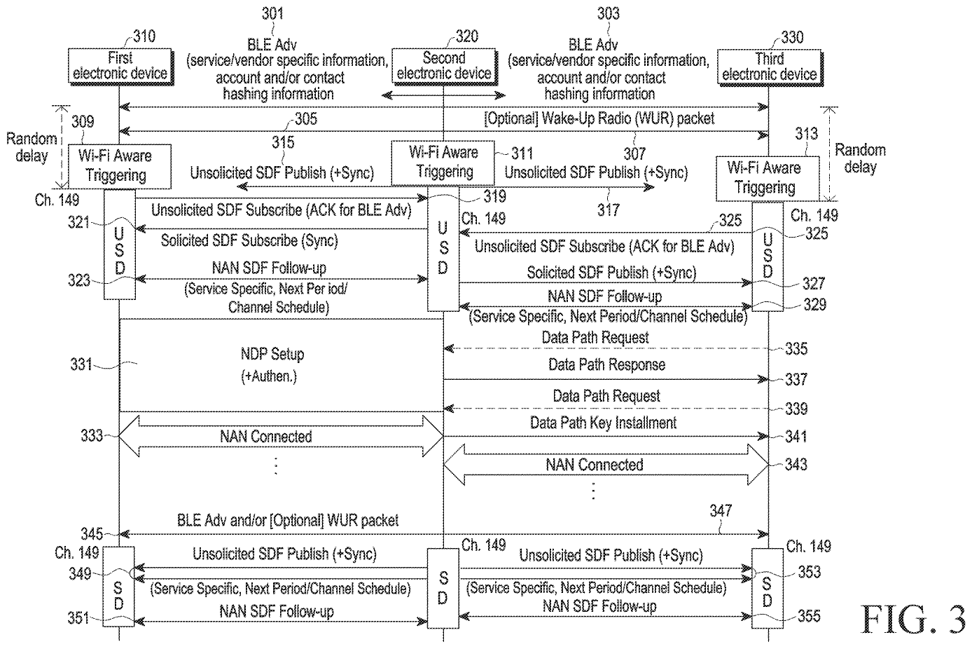

FIG. 3 is a view illustrating an unsynchronized service discovery (USD) operation of Wi-Fi Aware devices according to an embodiment of the disclosure.

Referring to FIG. 3, a first electronic device 310 may be a Wi-Fi Aware device performing a receiver role, a second electronic device 320 may be a Wi-Fi Aware device performing a sender role, and a third electronic device 330 may be a Wi-Fi Aware device performing a receiver role.

In operation 301, the second electronic device 320 may transmit a BLE advertisement message including provided service information (e.g., Vendor/Service Specific information, account and/or contact hashing information) to the first electronic device 310. In operation 303, the second electronic device 320 may transmit a BLE advertisement message including provided service information (e.g., Vendor/Service Specific information, account and/or contact hashing information) to the third electronic device 330.

According to an embodiment, in operation 305, the second electronic device 320 may transmit a wake up radio (WUR) packet to the first electronic device 310. According to an embodiment, in operation 307, the second electronic device 320 may transmit a WUR packet to the third electronic device 330.

The second electronic device 320 may trigger a Wi-Fi Aware interface (receiver) of another electronic device using an out of band (OOB) message (e.g., BLE advertisement message or WUR packet).

In operation 309, the first electronic device 310 may trigger a Wi-Fi Aware interface within a random delay after receiving a BLE advertisement message or WUR packet from the second electronic device 320. In operation 311, the second electronic device 320 may trigger its own Wi-Fi Aware interface after transmitting a BLE advertisement message or WUR packet. In operation 313, the third electronic device 330 may trigger a Wi-Fi Aware interface within a random delay after receiving a BLE advertisement message or WUR packet from the second electronic device 320.

According to an embodiment, if the Wi-Fi Aware interface of the second electronic device 320 is activated, the second electronic device 320 may wait for reception of an SDF subscribe message as an ACK for the previous OOB message.

The first electronic device 310 to the third electronic device 330 may support fast discovery among multiple devices by performing unsynchronized service discovery (USD) on a predesignated channel (e.g., channel 149) after triggering a Wi-Fi Aware interface for each device.

According to an embodiment, in operations 315 and 317, the second electronic device 320 may transmit an unsolicited service discovery frame (SDF) publish message including synchronization information (sync). According to an embodiment, the synchronization information may include additional timing synchronization function (TSF) information for synchronization.

According to an embodiment, during a USD procedure on a predesignated channel (e.g., channel 149), in operation 319, the first electronic device 310 may transmit an unsolicited SDF subscribe message to the second electronic device 320 as an ACK for a BLE advertisement message. As an active subscriber, the first electronic device 310 may transmit an unsolicited SDF subscribe message without receiving a message from a publisher.

During the USD procedure, in operation 321, the second electronic device 320 may transmit a solicited SDF publish message including synchronization information (sync) to the first electronic device 310. The solicited SDF publish message may be a unicast message. According to an embodiment, the synchronization information may include additional timing synchronization function (TSF) information for synchronization. In operation 323, the first electronic device 310 and the second electronic device 320 may exchange NAN SDF Follow-up messages. According to an embodiment, the NAN SDF Follow-up message may be a service specific message and may include schedule information for a next period and/or channel.

According to an embodiment, during a USD procedure on a predesignated channel (e.g., channel 149), in operation 325, the third electronic device 330 may transmit an unsolicited SDF subscribe message to the second electronic device 320 as an ACK for a BLE advertisement message. As an active subscriber, the third electronic device 330 may transmit an unsolicited SDF subscribe message without receiving a message from a publisher.

During the USD procedure, in operation 327, the third electronic device 330 may transmit a solicited SDF publish message including synchronization information (sync) to the first electronic device 310. The solicited SDF publish message may be a unicast message. According to an embodiment, the synchronization information may include additional timing synchronization function (TSF) information for synchronization. In operation 329, the third electronic device 330 and the second electronic device 320 may exchange NAN SDF Follow-up messages. According to an embodiment, the NAN SDF Follow-up message may be a service specific message and may include schedule information for a next period and/or channel.

In operation 331, the first electronic device 310 and the second electronic device 320 may perform a NAN data path (NDP) setup procedure. The NDP setup procedure may include an authentication procedure. In operation 333, a NAN connection may be established between the first electronic device 310 and the second electronic device 320.

In operation 335, the third electronic device 330 transmits a Data Path Request message to the second electronic device 320 and, in operation 337, the third electronic device 330 may receive a Data Path Response message from the second electronic device 320. In operation 339, the third electronic device 330 transmits a Data Path Request message to the second electronic device 320 and, in operation 341, the third electronic device 330 may receive a Data Path Key Installment message from the second electronic device 320. In operation 343, a NAN connection may be established between the third electronic device 330 and the second electronic device 320.

In operation 345, the second electronic device 320 may transmit a BLE advertisement message and/or WUR packet to the first electronic device 310. In operation 347, the second electronic device 320 may transmit a BLE advertisement message and/or WUR packet to the third electronic device 330.

During a service discovery (SD) procedure on a predesignated channel (e.g., channel 149), in operation 349, the second electronic device 320 may transmit an unsolicited SDF publish message including synchronization information (sync) to the first electronic device 310. According to an embodiment, the synchronization information may include additional timing synchronization function (TSF) information for synchronization. In operation 351, the first electronic device 310 and the second electronic device 320 may exchange NAN SDF Follow-up messages.

During an SD procedure on a predesignated channel (e.g., channel 149), in operation 353, the second electronic device 320 may transmit an unsolicited SDF publish message including synchronization information (sync) to the third electronic device 330. According to an embodiment, the synchronization information may include additional timing synchronization function (TSF) information for synchronization. In operation 355, the third electronic device 330 and the second electronic device 320 may exchange NAN SDF Follow-up messages.

According to an embodiment, if an NDP is established, data may be transmitted between Wi-Fi Aware devices included in a cluster. According to a specific service type, the next timing of a service discovery period, DW, and operating channel may be reserved by SDF publish/subscribe and NAN SDF follow-up messages.

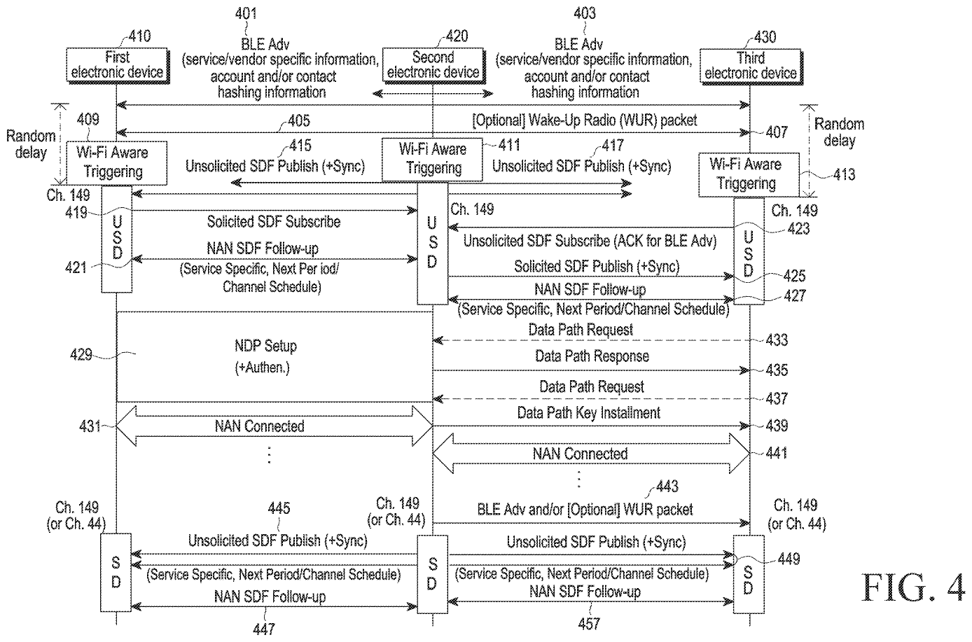

FIG. 4 is a view illustrating an unsynchronized service discovery (USD) operation of Wi-Fi Aware devices according to another embodiment of the disclosure.

Referring to FIG. 4, a first electronic device 410 may be a Wi-Fi Aware device performing a receiver role, a second electronic device 420 may be a Wi-Fi Aware device performing a sender role, and a third electronic device 430 may be a Wi-Fi Aware device performing a receiver role.

In operation 401, the second electronic device 420 may transmit a BLE advertisement message including provided service information (e.g., Vendor/Service Specific information, account and/or contact hashing information) to the first electronic device 410. In operation 403, the second electronic device 420 may transmit a BLE advertisement message including provided service information (e.g., Vendor/Service Specific information, account and/or contact hashing information) to the third electronic device 430.

According to an embodiment, in operation 405, the second electronic device 420 may transmit a wake up radio (WUR) packet to the first electronic device 410. According to an embodiment, in operation 407, the second electronic device 420 may transmit a WUR packet to the third electronic device 430.

In operation 409, the first electronic device 410 may trigger a Wi-Fi Aware interface within a random delay after receiving a BLE advertisement message or WUR packet from the second electronic device 420. In operation 411, the second electronic device 420 may trigger its own Wi-Fi Aware interface after transmitting a BLE advertisement message or WUR packet. In operation 413, the third electronic device 430 may trigger a Wi-Fi Aware interface within a random delay after receiving a BLE advertisement message or WUR packet from the second electronic device 420.

According to an embodiment, in operations 415 and 417, the second electronic device 420 may transmit an unsolicited service discovery frame (SDF) publish message including synchronization information (sync). According to an embodiment, the synchronization information may include additional timing synchronization function (TSF) information for synchronization.

According to an embodiment, during a USD procedure on a predesignated channel (e.g., channel 149), the first electronic device 410 may receive an unsolicited SDF publish message from the second electronic device 420. In operation 419 of the USD procedure, the first electronic device 410 may transmit a solicited SDF subscribe message to the second electronic device 420. The solicited SDF subscribe message may be a unicast message. In operation 421 of the USD procedure, the first electronic device 410 and the second electronic device 420 may exchange NAN SDF Follow-up messages. According to an embodiment, the NAN SDF Follow-up message may be a service specific message and may include schedule information for a next period and/or channel.

Each of operations 423 to 441 of FIG. 4 is identical to each of operations 325 to 343 of FIG. 3, and thus a description thereof is omitted.

In operation 443, the second electronic device 420 may transmit a BLE advertisement message and/or a WUR packet to the third electronic device 430 through a predetermined channel (e.g., channel 149 or channel 44). According to an embodiment, a channel on which operation 443 is performed and a channel on which a USD operation is performed may be different from each other.

During a service discovery (SD) procedure on a predesignated channel (e.g., channel 149 or channel 44), in operation 445, the second electronic device 420 may transmit an unsolicited SDF publish message including synchronization information (sync) to the first electronic device 410. According to an embodiment, the synchronization information may include additional timing synchronization function (TSF) information for synchronization. In operation 447, the first electronic device 410 and the second electronic device 420 may exchange NAN SDF Follow-up messages.

During an SD procedure on a predesignated channel (e.g., channel 149 or channel 44), in operation 449, the second electronic device 420 may transmit an unsolicited SDF publish message including synchronization information (sync) to the third electronic device 430. In operation 451, the third electronic device 430 and the second electronic device 420 may exchange NAN SDF Follow-up messages.

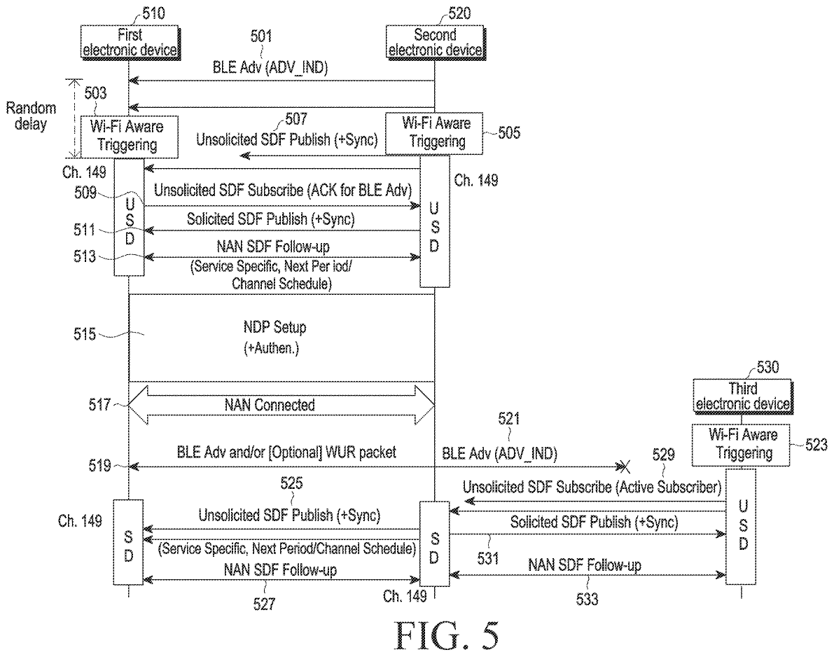

FIG. 5 is a view illustrating an unsynchronized service discovery (USD) operation of Wi-Fi Aware devices according to another embodiment of the disclosure.

Referring to FIG. 5, a first electronic device 510 may be a Wi-Fi Aware device performing a receiver role, a second electronic device 520 may be a Wi-Fi Aware device performing a sender role, and a third electronic device 530 may be a Wi-Fi Aware device performing a receiver role.

In operation 501, the second electronic device 520 may transmit a BLE advertisement message including an advertisement indicator (ADV IND) to the first electronic device 510. According to an embodiment, the second electronic device 520 may transmit a plurality of BLE advertisement messages to the first electronic device 510.

In operation 503, the first electronic device 510 may trigger a Wi-Fi Aware interface within a random delay after receiving the BLE advertisement message from the second electronic device 520. In operation 505, the second electronic device 520 may trigger its Wi-Fi Aware interface after transmitting the BLE advertisement message.

The first electronic device 510 and the second electronic device 520 may support fast discovery among multiple devices by performing USD in a predetermined channel (e.g., channel 149) after triggering a Wi-Fi Aware interface for each device.

According to an embodiment, in operation 507, the second electronic device 520 may transmit an unsolicited SDF publish message including synchronization information (sync). According to an embodiment, the synchronization information may include additional timing synchronization function (TSF) information for synchronization.

According to an embodiment, during a USD procedure on a predesignated channel (e.g., channel 149), in operation 509, the first electronic device 510 may transmit an unsolicited SDF subscribe message to the second electronic device 520 as an ACK for a BLE advertisement message. During the USD procedure, in operation 511, the second electronic device 520 may transmit a solicited SDF publish message including synchronization information (sync) to the first electronic device 510. The solicited SDF publish message may be a unicast message. In operation 513, the first electronic device 510 and the second electronic device 520 may exchange NAN SDF Follow-up messages. According to an embodiment, the NAN SDF Follow-up message may be a service specific message and may include schedule information for a next period and/or channel.

In operation 515, the first electronic device 510 and the second electronic device 520 may perform a NAN data path (NDP) setup procedure. The NDP setup procedure may include an authentication procedure. In operation 517, a NAN connection may be established between the first electronic device 510 and the second electronic device 520.

In operation 519, the second electronic device 520 may transmit a BLE advertisement message and/or WUR packet to the first electronic device 510. In operation 521, the second electronic device 520 transmits a BLE advertisement message including an advertisement indicator, but the third electronic device 530 may not receive the BLE advertisement message. In operation 523, the third electronic device 530 may trigger its Wi-Fi Aware interface based on user input and/or setting conditions.

During a service discovery (SD) procedure on a predesignated channel (e.g., channel 149), in operation 525, the second electronic device 520 may transmit an unsolicited SDF publish message including synchronization information (sync) to the first electronic device 510. According to an embodiment, the synchronization information may include additional timing synchronization function (TSF) information for synchronization. In operation 527, the first electronic device 510 and the second electronic device 520 may exchange NAN SDF Follow-up messages.

In operation 529, the third electronic device 530 may transmit an unsolicited SDF subscribe message including an Active Subscriber. When the second electronic device 520 receives the unsolicited SDF subscribe message, in operation 531 during an SD procedure in a predesignated channel (e.g., channel 149), the second electronic device 520 may transmit a solicited SDF publish message including synchronization information (sync) to the third electronic device 530. According to an embodiment, the synchronization information may include additional timing synchronization function (TSF) information for synchronization. In operation 533, the third electronic device 530 and the second electronic device 520 may exchange NAN SDF Follow-up messages.

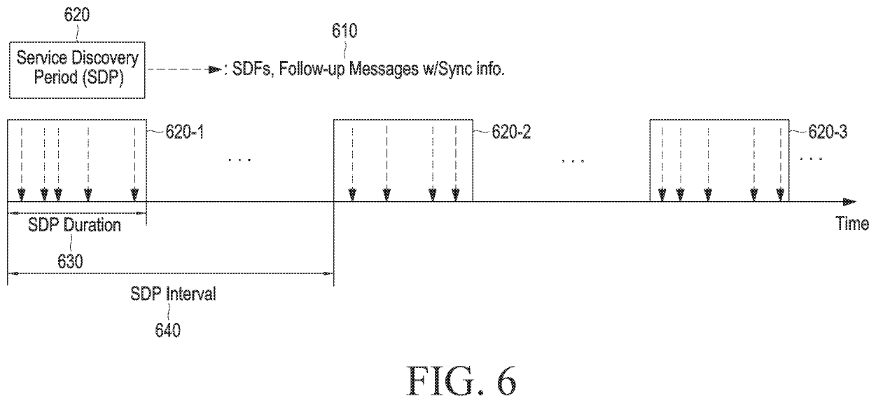

FIG. 6 is a view illustrating a service discovery period (SDP) according to an embodiment of the disclosure.

FIG. 6 is a view encompassing a USD operation according to an embodiment of the disclosure, and the above-described FIGS. 3 to 5 describe specific operations of the USD operation. Referring to FIG. 6, at least one electronic device may transmit a service discovery frame (SDF) message and/or a Follow up message 610 including synchronization information in an SDP 620.

The at least one electronic device may transmit a service discovery frame (SDF) message and/or a Follow up message 610 including synchronization information in each of a first SDP 620-1 to a third SDP 620-3. According to an embodiment, each of an SDP duration 630 and an SDP interval 640 may be preset as a specific TU.

A USD operation is introduced to simplify and accelerate an initial device/service discovery flow, and a discovery beacon that indicates a start time of a discovery window (DW) may also be skipped in an initial USD operation. In this case, roles of an anchor master node and a NAN master node that perform roles related to discovery beacon broadcasting may also be skipped, and a NAN role may be simplified to two roles of master and non-master for a cluster. According to an embodiment, synchronization information may be transmitted at any time from devices having these two roles. Due to this simplification, cluster coverage may be decreased to a TX range of a master node because there is no need to relay and forward discovery beacons to further extend cluster coverage.

According to an embodiment, sync nodes and non-sync nodes defined in Wi-Fi Aware may also be removed when all cluster members participate in a synchronization phase to exchange TSF information. The synchronization phase may be selectively omitted by combining USD and the synchronization phase. By introducing implicit synchronization using SDF, time required for synchronization (i.e., transmitting/receiving sync beacon frames in a designated DW) may be further decreased.

According to an embodiment, a NAN role may be simplified to master and non-master through removal of discovery beacons. Further, NAN roles for sync and non-sync nodes may also be omitted, and all cluster nodes may participate in a synchronization phase in an implicit manner. For this, essential TSF information for synchronization may be additionally included in a piggyback manner in a NAN SDF Publish message, an SDF Subscribe message, and/or an SDF follow-up message.

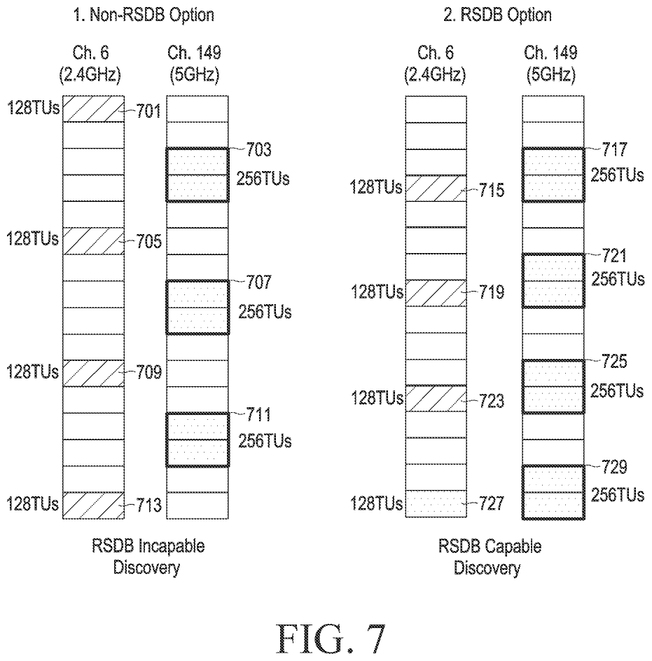

FIG. 7 illustrates examples of channel and time resource operation according to whether real-time simultaneous dual band (RSDB) is operated according to an embodiment of the disclosure.

The examples of RSDB incapable unsynchronized Service Discovery (USD) operation and RSDB capable USD operation illustrated in FIG. 7 are merely examples for convenience of description, and the technical spirit of the disclosure is not limited thereto, and each of RSDB incapable USD and RSDB capable USD operation may be variously implemented according to design specifications.

In the case of an RSDB incapable USD operation, a first USD operation 701 may be performed for a set time (e.g., 128 TUs) in a first channel/band (e.g., channel 6 of 2.4 GHz), and a second USD operation 703 may be performed for a set time (e.g., 256 TUs) in a second channel/band (e.g., channel 149 of 5 GHz). Each of the first USD operation 701 and the second USD operation 703 is performed between at least two electronic devices and may not proceed simultaneously in time.

In the case of an RSDB incapable USD operation, a third USD operation 705 may be performed for a set time (e.g., 128 TUs) in a first channel/band (e.g., channel 6 of 2.4 GHz), and a fourth USD operation 707 may be performed for a set time (e.g., 256 TUs) in a second channel/band (e.g., channel 149 of 5 GHz). Each of the third USD operation 705 and the second USD operation 703 is performed between at least two electronic devices and may not proceed simultaneously in time. Thereafter, similarly, each of a fifth USD operation 709, a sixth USD operation 711, and a seventh USD operation 713 may be performed.

In the case of an RSDB capable USD operation, an eighth USD operation 715 may be performed for a set time (e.g., 128 TUs) in a first channel/band (e.g., channel 6 of 2.4 GHz), and a ninth USD operation 717 may be performed for a set time (e.g., 256 TUs) in a second channel/band (e.g., channel 149 of 5 GHz). Each of the eighth USD operation 715 and the ninth USD operation 717 is performed between at least two electronic devices operating RSDB and may proceed simultaneously in time.

In the case of an RSDB capable USD operation, a tenth USD operation 719 may be performed for a set time (e.g., 128 TUs) in a first channel/band (e.g., channel 6 of 2.4 GHz), and an eleventh USD operation 721 may be performed for a set time (e.g., 256 TUs) in a second channel/band (e.g., channel 149 of 5 GHz). Each of the tenth USD operation 719 and the eleventh USD operation 721 is performed between at least two electronic devices operating RSDB and may proceed simultaneously in time. Thereafter, similarly, each of a twelfth USD operation 723, a thirteenth USD operation 725, a fourteenth USD operation 727, and a fifteenth USD operation 729 may be performed.

According to an embodiment, a plurality of USD operations may be simultaneously performed in multiple bands or channels to further reduce total dwell time of all channels. According to an embodiment, to simultaneously perform USD operations in multiple bands or channels, periods/intervals may need to be separately managed for each band or channel.

According to an embodiment, an RSDB function may reduce search latency when there are legacy Wi-Fi Aware devices operating in 2.4 GHz channels. When there is an NDP requiring intensive data transmission in 5 GHz, search operations may be performed in 2.4 GHz.

According to an embodiment, simultaneous operations for USD/SD in multiple bands or channels may be coordinated through RSDB or virtual simultaneous dual band (VSDB) functions. According to an embodiment, a duration of a service discovery period (USD/SD) may be adjusted according to conditions such as AP connection, data traffic, and service type. According to an embodiment, a duration of each period may be set to a specific value of TU. These values may be determined in a static or dynamic manner.

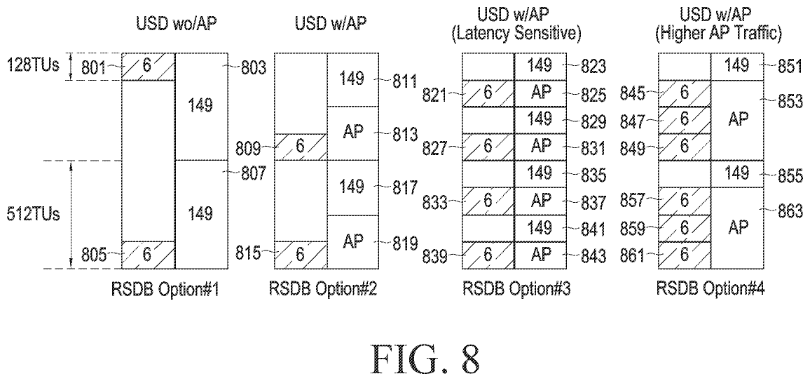

FIG. 8 illustrates examples of channel and time resource operation according to various conditions in an RSDB operable circumstance according to an embodiment of the disclosure.

The examples of each of RSDB Option #1 to RSDB Option #4 illustrated in FIG. 8 are merely examples for convenience of description, and the technical spirit of the disclosure is not limited thereto, and each of RSDB Option #1 to RSDB Option #4 may be variously implemented according to design specifications.

RSDB Option #1 illustrates an example of channel and time resource operation when there is no AP connection in an RSDB operable circumstance. A first USD operation 801 may be performed for a set time (e.g., 128 TUs) in a first channel/band (e.g., channel 6 of 2.4 GHz), and a second USD operation 803 may be performed for a set time (e.g., 512 TUs) in a second channel/band (e.g., channel 149 of 5 GHz). Each of the first USD operation 801 and the second USD operation 803 is performed between at least two electronic devices operating RSDB and may proceed simultaneously in time. Thereafter, a third USD operation 805 and a fourth USD operation 807 may be similarly performed. RSDB Option #1 may be a case of utilizing a first channel/band (e.g., channel 6 of 2.4 GHz) as a social channel (considering some legacy Wi-Fi Aware devices supporting only 2.4 GHz, band distribution between devices).

RSDB Option #2 illustrates an example of channel and time resource operation when there is an AP connection in an RSDB operable circumstance. A fifth USD operation 809 may be performed for a set time (e.g., 128 TUs) in a first channel/band (e.g., channel 6 of 2.4 GHz), a sixth USD operation 811 may be performed for a set time (e.g., 256 TUs) in a second channel/band (e.g., channel 149 of 5 GHz), and an AP-related operation 813 may be performed for a set time (e.g., 256 TUs) in the second channel/band (e.g., channel 149 of 5 GHz). Each of the fifth USD operation 809 and the AP-related operation 813 may proceed simultaneously in time. Thereafter, a seventh USD operation 815, an eighth USD operation 817, and an AP-related operation 819 may be similarly performed. RSDB Option #2 may support Aware discovery in some 2.4 GHz Ch. 6 even during a 5 GHz AP occupation period, with AP/Aware scheduling set to 5:5 for a second channel/band (e.g., channel 149 of 5 GHz).

RSDB Option #3 illustrates an example of channel and time resource operation when there is an AP connection and it is latency sensitive in an RSDB operable circumstance. A ninth USD operation 821 may be performed for a set time (e.g., 128 TUs) in a first channel/band (e.g., channel 6 of 2.4 GHz), a tenth USD operation 823 may be performed for a set time (e.g., 128 TUs) in a second channel/band (e.g., channel 149 of 5 GHz), and an AP-related operation 825 may be performed for a set time (e.g., 128 TUs) in the second channel/band (e.g., channel 149 of 5 GHz). The ninth USD operation 821 and the AP-related operation 825 may proceed simultaneously in time. An eleventh USD operation 829 may be performed for a set time (e.g., 128 TUs) in a second channel/band (e.g., channel 149 of 5 GHz), a twelfth USD operation 827 may be performed for a set time (e.g., 128 TUs) in a first channel/band (e.g., channel 6 of 2.4 GHz), and an AP-related operation 831 may be performed for a set time (e.g., 128 TUs) in the second channel/band (e.g., channel 149 of 5 GHz). The twelfth USD operation 827 and the AP-related operation 831 may proceed simultaneously in time. Thereafter, USD operations 833, 835, 839, 841 and AP-related operations 837, 843 may be similarly performed.

RSDB Option #4 illustrates an example of channel and time resource operation when there is an AP connection and higher AP traffic is present in an RSDB operable circumstance. A thirteenth USD operation 851 may be performed for a set time (e.g., 128 TUs) in a second channel/band (e.g., channel 149 of 5 GHz), each of fourteenth to sixteenth USD operations 845, 847, 849 may be performed for a set time (e.g., 128 TUs) in a first channel/band (e.g., channel 6 of 2.4 GHz), and an AP-related operation 853 may be performed for a set time (e.g., 384 TUs) in the second channel/band (e.g., channel 149 of 5 GHz). The ninth USD operation 821 and the AP-related operation 825 may proceed simultaneously in time. Thereafter, USD operations 855, 857, 859, 861 and AP-related operations 863 may be similarly performed.

In RSDB Option #3, when AP traffic in a 5 GHz band (Ch. 149) is latency sensitive (e.g., voice/conference call), time may be allocated to an AP more frequently and uniformly (5:5). In RSDB Option #4, when AP traffic is heavy (e.g., high volume data transfer), Aware discovery may be supported in 2.4 GHz Ch. 6 during a 5 GHz AP occupation period in a circumstance of allocating more time to an AP (2.5:7.5). An AP connection may mainly use 5 GHz and a 2.4 GHz Ch. 6 may be utilized as a social channel (considering some legacy Wi-Fi Aware devices supporting only 2.4 GHz, band distribution between devices).

According to an embodiment, a duration of a service discovery period (USD/SD) may be adjusted according to conditions such as AP connection, data traffic, and service type. According to an embodiment, a duration of each period may be set to a specific value of TU. These values may be determined in a static or dynamic manner.

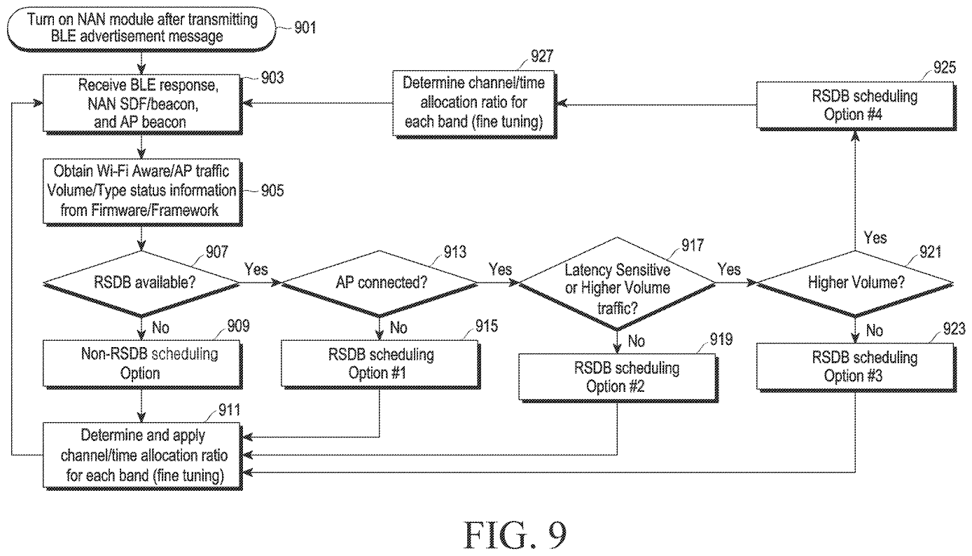

FIG. 9 is a flowchart for describing an operation of an electronic device according to an embodiment of the disclosure. The electronic device of FIG. 9 may be implemented as a Wi-Fi Aware device performing a sender role.

In operation 901, the electronic device may transmit a BLE advertisement message and turn on a NAN module (or Wi-Fi Aware interface). In operation 903, the electronic device may receive a BLE response message, a NAN SDF/beacon, and/or an AP beacon.

In operation 905, the electronic device may obtain Wi-Fi Aware/AP traffic volume information and/or Wi-Fi Aware/AP type status information from firmware or a framework.

In operation 907, the electronic device may identify whether real-time simultaneous dual band (RSDB) function is available. If the RSDB function is not available in operation 907 (907-No), in operation 909, the electronic device may perform a USD operation through a Non-RSDB scheduling Option as illustrated in FIG. 7. Thereafter, in operation 911, the electronic device may determine and apply a channel and/or time allocation ratio for each band (fine tuning).

If the RSDB function is available in operation 907 (907-Yes), in operation 913, the electronic device may identify whether AP connection is possible. If AP connection is not possible in operation 913 (913-No), in operation 915, the electronic device may perform a USD operation based on RSDB scheduling Option #1 illustrated in FIG. 8. Thereafter, in operation 911, the electronic device may determine and apply a channel and/or time allocation ratio for each band (fine tuning).

If AP connection is possible in operation 913 (913-Yes), in operation 917, the electronic device may identify whether AP traffic is latency sensitive or higher volume traffic. If AP traffic is not latency sensitive and is not higher volume traffic in operation 917 (917-No), in operation 919, the electronic device may perform a USD operation based on RSDB scheduling Option #2 illustrated in FIG. 8. Thereafter, in operation 911, the electronic device may determine and apply a channel and/or time allocation ratio for each band (fine tuning).

If AP traffic is latency sensitive or higher volume traffic in operation 917 (917-Yes), in operation 921, the electronic device may identify whether AP traffic is higher volume traffic.

If AP traffic is not higher volume traffic (i.e., AP traffic is latency sensitive) in operation 921 (921-No), in operation 923, the electronic device may perform a USD operation based on RSDB scheduling Option #3. Thereafter, in operation 911, the electronic device may determine and apply a channel and/or time allocation ratio for each band (fine tuning).

If AP traffic is higher volume traffic in operation 921 (921-Yes), in operation 925, the electronic device may perform a USD operation based on RSDB scheduling Option #4. Thereafter, in operation 927, the electronic device may determine and apply a channel and/or time allocation ratio for each band (fine tuning). According to an embodiment, after operation 927, the electronic device may perform operation 903 again if necessary.

In the disclosure, advanced device/service discovery control (ADSDC) data related to operation 905 may be recorded inside the electronic device (or sysfs node (/sys/wifi/nan)) or received from another node and provided to NAN firmware (chip side).

The ADSDC data may include at least one of fields in Table 1.

TABLE 1

| | | | | Expected FW |
|---|---|---|---|---|
| | Size | | | operation |
| Field | (bits) | Description | Value | (Requirement) |
| OUI | 8 | Vendor | 64 (01000000) | Be aware of OUI, |
| | | specific OUI | | and can decrypt |
| | | type | | ADSDC data |
| Length | 8 | Length of this | 0x00~0xFF | Take into account |
| | | OUI data | | for this field as |
| | | | | length of ADSDC |
| | | | | data. |
| Type | 2 | ADSDC | 00: Request | Be aware of |
| | | packet type | 01: Request (Response | ADSDC packet |
| | | | not required) | type |
| | | | 10: Response | |
| | | | 11: Confirm | |
| Subtype | 3 | Synchronization | 000: Return to original | NAN device |
| | | reference | NAN operation (Standard | decrypts the |
| | | | NAN Cluster) | following data |
| | | | 001: Another NAN | field correctly |
| | | | Cluster | according to this |
| | | | 010: Connected Access | subtype value. |
| | | | Point (AP) | |
| | | | 011: Other proxy | |
| | | | (Beaconing device) | |
| | | | 100: Advanced NAN | |
| | | | operation including sync | |
| | | | piggyback SDF | |
| | | | 101-110: Reserved | |
| | | | 111: Original NAN | |
| | | | operation which has | |
| | | | discovery beacon and DW | |
| | | | plus advanced NAN | |
| | | | operations using 100 | |
| | | | subtype | |
| Channel type | 2 | Indicate the | 00: Discovery channel | Interpret this |
| | | type of channel | 01: Operating channel for | value to identify |
| | | with respect | data transfer | the usage of |
| | | to the purpose | 10: WUR channel | channel |
| | | | 11: Reserved | |
| Simultaneous | 2 | Indicate the | 00: Disable | Interpret this |
| operation | | capability of | 01~10: Reserved (for | value to identify |
| control on multi- | | simultaneous | specific multi-antennas | the capability of |
| band/channel | | operations on | configuration) | simultaneous |
| | | multiple bands | 11: Enable | operations on |
| | | or channels | | multiple bands for |
| | | | | RSDB feature |
| Length of | 4 | Length of the | 0x00~0x0F | |
| channel list | | channel list | | |
| | | according to | | |
| | | the channel | | |
| | | type | | |
| Band | 4 | Indicate the | 0000: Various Band | Refer this for |
| | | frequency | Indication | band entry when |
| | | band that this | 0001: Sub-1 GHz | apply scheduling |
| | | applies | 0010: 2.4 GHz | bitmap |
| | | | 0011: 5 GHz | |
| | | | 0100: 6 GHz | |
| | | | 0101: 60 GHz | |
| | | | 0101~1111: Reserved | |
| Channel | 4 | Reserved for | Reserved | Interpret this |
| | | byte alignment | | value for channel |
| | | | | entry of schedule |
| | | | | of corresponding |
| | | | | band |
| Channel quality | 2 | Indicate the | 00: Received signal | Interpret this |
| report type | | report type for | strength (dBm) | value for channel |
| | | channel | 01: Quantized signal level | quality report |
| | | quality | 10: Signal to noise ratio | type |
| | | | (dB) | |
| | | | 11: Reserved | |
| Master selection | 2 | Determine the | 00: Default NAN | FW changes its |
| rule | | master | 01: Initial sender having | NAN role |
| | | selection rule | SDF publisher role | according to the |
| | | | becomes master (static) | specified |
| | | | 10: Advanced NAN | selection rule. |
| | | | operation capable device | |
| | | | becomes master | |
| | | | 11: Reserved | |
| Master selection | 1 | Determine the | 0: Master | Interpret this |
| | | master role | 1: Non-master | value for |
| | | | | assigning the |
| | | | | simplified NAN |
| | | | | role |
| Role selection | 2 | Determine | 00: Publisher using both | Interpret this |
| for service | | specific type | types of solicited and | value for |
| discovery | | of publisher/ | unsolicited SDF publish | assigning specific |
| | | subscriber | messages | role of |
| | | | 01: Publisher using | publisher/ |
| | | | solicited SDF publish | subscriber |
| | | | message only | |
| | | | 10: Active subscriber | |
| | | | 11: Passive subscriber | |
| SDF type | 2 | Indicate type | 00: Original SDF | Interpret this |
| | | of SDF | 01~10: Reserved | value for |
| | | | 11: Sync piggyback SDF | identifying the |
| | | | | type of SDF |
| Period type | 2 | Indicate the | 00: Initial USD period | Interpret this |
| | | type of period | 01: SD period | value for |
| | | | 10: Reserved | identifying the |
| | | | 11: DW period | type of period |
| SD period | 4 | NAN device | 0: Do not wake up on SD | 0: Awake only |
| interval | | shall wake up | period | when OOB wake- |
| | | after SD | 1 (=2\hat{ }1): Wake up | up message (BLE |
| | | period interval | interval between prior SD | or WUR packet) |
| | | from the prior | period and the next SD | is received |
| | | end timing of | period is 2TUs. | Others: Awake on |
| | | SD period. | 1111 (=2\hat{ }15): Wake up | the start timing of |
| | | | interval is 2\hat{ }15(=32768) | SD period after |
| | | | TUs. | the SD period |
| | | | | interval is passed |
| SD period | 4 | NAN device | 0: Do not wake up | 0: Sleep until |
| duration | | shall wait for | 1 (=8*2): Wake up at the | OOB wake-up |
| | | listening to | SD period during 16TUs | message (BLE or |
| | | frames during | 1111(=8*16): Wake up at | WUR packet) is |
| | | SD period | the SD period during | received |
| | | duration. | 128TUs | Others: Awake |
| | | | | during SD period |
| | | | | duration |

The ADSDC data may include at least one of fields in Table 2.

TABLE 2

| | | | | Expected FW |
|---|---|---|---|---|
| | Size | | | operation |
| Field | (bits) | Description | Value | (Requirement) |
| DW interval | 4 | NAN device should | 0: Do not wake up | 0: Sleep until OOB |
| | | wake up after DW | on DW | wake-up message |
| | | interval from the prior | 1 (=2\hat{ }1): Wake | (BLE or WUR |
| | | end timing of DW. | up interval | packet) is received |
| | | | between prior and | Others: Awake on the |
| | | | the next DWs is | start timing of DW |
| | | | 2TUs. 1111 (=2\hat{ }15): | after the DW interval |
| | | | Wake up interval is | is passed |
| | | | 2\hat{ }15(=32768) TUs. | |
| DW duration | 4 | NAN device should | 0: Do not wake up | 0: Sleep until OOB |
| | | wait for listening to | 1 (=16*1): Wake | wake-up message |
| | | sync beacon and SDF | up at the DW | (BLE or WUR |
| | | during DW duration. | during 8TUs | packet) is received |
| | | | 1111(=16*15): | Others: Awake on DW |
| | | | Wake up at the | |
| | | | DW during 240TUs | |
| Duration of | 4 | For the initial USD, | 0: Do not wake up | Others: The |
| dwell period | | sender device shall | on USD period | minimum amount of |
| for initial | | await during a specific | (Off USD period) | time spent on a |
| USD in | | dwell period duration | 1: Listen to a | channel is 64TUs. |
| sender | | per channel in order to | specific channel | |
| | | listens to | for 1*64TUs | |
| | | any subscribe message. | (Default) | |
| | | | 1111 (=15): | |
| | | | Listen to a specific | |
| | | | channel for 15*64 | |
| | | | (=960) TUs | |
| Timeout for | 4 | For the initial USD, | 0: Do not wake up | 0: Awake only when |
| initial USD | | sender device shall re- | on USD period | OOB wake-up |
| retry of | | try after timeout for | 1 (=2\hat{ }1): Wake | message (BLE or |
| sender | | initial USD retry, when | up interval | WUR packet) is |
| | | the sender does not | between prior and | received |
| | | receive the subscribe | posterior USD | Others: Be capable of |
| | | messages at the prior | periods is 2TUs. | re-try on the USD |
| | | dwell period for USD. | 1111 (=2\hat{ }15): | period until the |
| | | | Wake up interval | timeout for USD |
| | | | is 2\hat{ }15(=32768) | retry is passed |
| | | | TUs. | |
| Interval | 4 | NAN master device | 0: Do not send | FW exploits this |
| between | | should send the | multiple messages | value only when role |
| unsolicited | | unsolicited SDF | but send a single | selection for service |
| SDF publish | | publish messages at an | message | discovery is 00. |
| messages | | interval | 1 (=1)): Send | 0: Send a single |
| | | | multiple messages | message |
| | | | at an interval of | Others: Send |
| | | | ITU | multiple messages at |
| | | | 1111 (=15): Send | an interval |
| | | | multiple messages | |
| | | | at an interval of 15TUs | |
| Number of | 4 | Indicate the number of | 0: Do not send | FW exploits this |
| unsolicited | | unsolicited SDF | message | value only when role |
| SDF publish | | publish messages | 1 (=1): Send a | selection for service |
| messages in | | during USD or SD | single message | discovery is 00. |
| USD or SD | | period (at an interval) | 1111 (=15): Send | Interpret this value |
| period | | | fifteen sequential | for identifying the |
| | | | messages | number of |
| | | | | unsolicited SDF |
| | | | | publish messages in a |
| | | | | SD period, when an |
| | | | | interval of messages |
| | | | | is set to a fixed value) |
| | | | | 0: Do not send the |
| | | | | unsolicited SDF |
| | | | | publish message, |
| | | | | when role selection |
| | | | | for service discovery |
| | | | | is 00. |
| | | | | Others: Send |
| | | | | unsolicited SDF |
| | | | | publish message(s) |
| Timeout of | 4 | For the initial USD, | 0: Re-try to | 0: Re-try until |
| receiver for | | receiver subscriber | transmit SDF | unsolicited/solicited |
| initial USD | | device shall re-try to | subscribe message | SDF publish or |
| | | transmit SDF subscribe | on the USD period | follow-up message is |
| | | message after timeout | until subscriber | received |
| | | of subscriber, when the | receives the | Others: Awake for |
| | | subscriber does not | unsolicited SDF | the timeout duration |
| | | receive the follow-up | publish or follow- | |
| | | message. | up message | |
| | | | 1 (=2\hat{ }1): | |
| | | | Timeout duration | |
| | | | becomes 2TUs. | |
| | | | 1111 (=2\hat{ }15): | |
| | | | Timeout duration | |
| | | | becomes 2\hat{ }15(=32768) | |
| | | | TUs. | |
| Interval | 4 | NAN master device | 0: Do not send | FW exploits this |
| between | | should send the | multiple messages | value only when role |
| unsolicited | | unsolicited SDF | but send a single | selection for service |
| SDF | | subscribe messages at | message | discovery is 00. |
| subscribe | | an interval | 1 (=1)): Send | 0: Send a single |
| messages | | | multiple messages | message |
| | | | at an interval of | Others: Send |
| | | | 1TU | multiple messages at |
| | | | 1111 (=15): Send | an interval |
| | | | multiple messages | |
| | | | at an interval of | |
| | | | 15TUs | |
| Number of | 4 | Indicate the number of | 0: Do not send | FW exploits this |
| unsolicited SDF | | unsolicited SDF | message | value only when role |
| subscribe | | subscribe messages | 1 (=1): Send a | selection for service |
| messages in | | during USD or SD | single message | discovery is 10 or 11. |
| USD or SD | | period (at an interval) | 1111 (=15): Send | Interpret this value |
| period | | | fifteen sequential | for identifying the |
| | | | messages | number of |
| | | | | unsolicited SDF |
| | | | | publish messages in a |
| | | | | SD period, when an |
| | | | | interval of messages |
| | | | | is set to a fixed value) |
| | | | | 0: Do not send the |
| | | | | unsolicited SDF |
| | | | | subscribe message, |
| | | | | when role selection |
| | | | | for service discovery |
| | | | | is not 10. |
| | | | | Others: Send |
| | | | | unsolicited SDF |
| | | | | subscribe message(s) |
| Data | 1 | Indicate the capability | 0: Disable | Interpret this value to |
| fragmentation | | of data fragmentation | 1: Enable | identify the |
| control inside | | inside NAN SDF | | capability of data |
| NAN SDF | | | | fragmentation only |
| | | | | when the unicast |
| | | | | NAN SDFs (i.e., |
| | | | | Publish, Follow-up) |
| | | | | are used. |
| Control of | 1 | Indicate the capability | 0: Disable | Interpret this value to |
| Sync | | of sync piggyback data | 1: Enable | identify the |
| piggyback | | in the NAN SDF | | capability of sync |
| data | | | | piggyback only when |
| | | | | subtype field value is |
| | | | | 101 or 111. |
| Sync | Var. | Contain piggyback | | FW optionally |
| piggyback | | information for | | exploits the |
| data | | synchronization | | information defined |
| (optional) | | (Refer the Table 3.3.2) | | in Table 3.3.2 only |
| | | | | when subtype field |
| | | | | value is 101. |

Sync piggyback information included in an SDF message according to an embodiment of the disclosure may include at least one of fields in Table 3.

TABLE 3

| | | | | | Expected FW |
|---|---|---|---|---|---|
| | | Size | | | operation |
| Type | Field | (Octets) | Description | Value | (Requirement) |
| NAN Sync | Length of | 2 | Length of this | 00:00~FF:FF | Take into |
| Piggyback | piggyback | | piggyback data | | account for |
| Information | data | | | | this field as |
| for SDF | | | | | length of |
| | | | | | Piggyback |
| | | | | | Sync data. |
| | NMI of | 6 | Identify NMI of | 00:00:00:00:00:00~ | Interpret this |
| | receiver (A1) | | receiver | FF:FF:FF:FF:FF:FF | value to |
| | | | | | identify the |
| | | | | | NMI of frame |
| | | | | | receiver |
| | NMI of | 6 | Identify NMI of | 00:00:00:00:00:00~ | Interpret this |
| | sender (A2) | | sender | FF:FF:FF:FF:FF:FF | value to |
| | | | | | identify the |
| | | | | | NMI of frame |
| | | | | | sender |
| | NAN Cluster | 6 | Identify NAN | 50:6F:9A:01:00:00~ | Interpret this |
| | ID (A3) | | Cluster ID | 50:6F:9A:01:FF:FF | value to |
| | | | | | identify the |
| | | | | | current NAN |
| | | | | | Cluster ID |
| | Timestamp | 8 | Time stamp | 0~FFFFFFFFFFFFFFFF | FW exploits |
| | | | | | this value for |
| | | | | | TSF. |
| | Capability | 2 | Capability | See Table. 30 | Interpret this |
| | | | information field | in [1] | value to |
| | | | | | identify |
| | | | | | capabilities of |
| | | | | | several |
| | | | | | features |
| | Sequence | 2 | Sequence | 00:00~FF:FF | FW exploits |
| | control | | control | | this value to |
| | | | | | control data |
| | | | | | fragmentation |
| | | | | | or to calculate |
| | | | | | frame error |
| | | | | | rate by |
| | | | | | accumulating |
| | | | | | the TX/RX |
| | | | | | results for |
| | | | | | multiple SDFs. |
| | Data | Var | Include the | | FW appends |
| | | | additional vendor | | the vendor |
| | | | specific data | | specific data |
| | | | | | to the SDF. |

For reference, in the “See Table. 30 in [1]” portion used as a value of a capability field in Table 3, reference [1] is Wi-Fi Aware Specification R4.

According to an embodiment, NAN firmware in an electronic device may operate according to the above-described ADSDC data. According to an embodiment, ADSDC data may be inserted into a NAN SDF, a NAN action frame, an NDP setup frame, a Wi-Fi frame, and/or a BLE/WUR OOB packet, and may be recognized by NAN firmware. Through internal transmission methods in an electronic device such as a NAN framework and a NAN hardware abstraction layer (HAL), NAN firmware may appropriately process data. An electronic device that receives an ADSDC request may decode this information and respond back to an initiator.

According to an embodiment, an ADSDC attribute may be composed of a plurality of parameters that coordinate an entire discovery operation. According to an embodiment, a synchronization method in a discovery operation may vary according to a subtype field of ADSDC data indicating a type of synchronization reference. (For example, when a value of the subtype field is 101, ADSDC data additionally includes information of Table 3)

According to an embodiment, if a sync piggyback SDF is exchanged in an SD cycle, NDP setup may be established in a shorter time. According to an embodiment, regarding a duration/interval control policy for an SD period or DW, a NAN device may consider a balance between search latency and energy saving when intended.

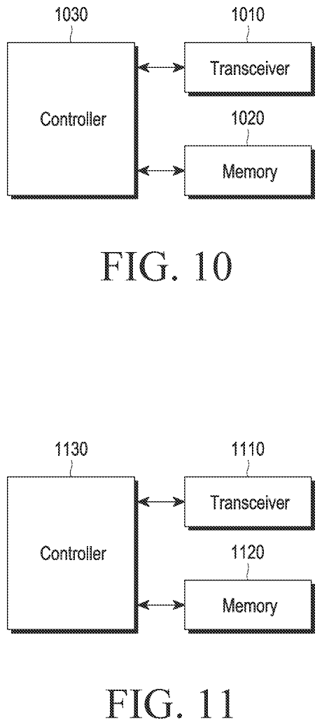

FIG. 10 is a view illustrating a structure of an electronic device (sender) according to an embodiment of the disclosure. The electronic device (sender) of FIG. 10 may be implemented as an electronic device or Wi-Fi Aware device performing a sender role illustrated in FIG. 3 to FIG. 9.

Referring to FIG. 10, the electronic device may include a transceiver 1010, a controller 1030, and a storage unit 1020. In the disclosure, the controller may be defined as a circuit or application-specific integrated circuit or at least one processor.

The transceiver 1010 may transmit and receive a signal to and from an external electronic device.

The controller 1030 may control the overall operation of the electronic device (sender) according to the embodiment proposed in the disclosure. For example, the controller 1020 may control inter-block signal flow to perform the operations according to the above-described flowchart. Specifically, a controller 1030 may control, e.g., operations of the electronic device (sender) illustrated in FIG. 3 to FIG. 9.

The storage unit 1020 may store at least one of information transmitted/received via the transceiver 1010 and information generated via the controller 1030.

According to an embodiment of the disclosure, an electronic device (sender) includes a transceiver 1010 and a controller 1030. The controller 1030 may transmit a Bluetooth low energy (BLE) advertisement message and activate a Wi-Fi Aware module of the electronic device. The controller 1030 may identify whether a real-time simultaneous dual band (RSDB) function is available. The controller 1030 may, if the RSDB function is available as a result of the identifying, select one RSDB scheduling option from among a plurality of RSDB scheduling options based on whether there is an access point (AP) connection of the electronic device and AP traffic characteristics. The controller 1030 may perform a discovery procedure according to the selected RSDB scheduling option.

According to an embodiment, the controller 1030 may, if the RSDB function is not available as a result of the identifying, perform the discovery procedure according to a Non-RSDB scheduling option.

According to an embodiment, the controller 1030 may, if the AP connection is not present, select a first RSDB scheduling option from among the plurality of RSDB scheduling options.

According to an embodiment, the controller 1030 may, if the AP connection is present and the AP traffic is not sensitive to delay and an amount of the AP traffic is less than a threshold, select a second RSDB scheduling option from among the plurality of RSDB scheduling options.

According to an embodiment, the controller 1030 may, if the AP connection is present and the AP traffic is sensitive to delay, select a third RSDB scheduling option from among the plurality of RSDB scheduling options.

According to an embodiment, the controller 1030 may, if the AP connection is present and an amount of the AP traffic is equal to or greater than a threshold, select a fourth RSDB scheduling option from among the plurality of RSDB scheduling options.

According to an embodiment, the controller 1030 may adjust at least one of a channel and a time allocation ratio for each band according to the selected RSDB scheduling option. According to an embodiment, the controller 1030 may obtain information about Wi-Fi Aware from firmware or a framework in the electronic device. According to an embodiment, the controller 1030 may obtain information about the AP traffic from the firmware or the framework in the electronic device.

According to an embodiment, the discovery procedure may include an unsynchronized service discovery USD operation. According to an embodiment, some options among the plurality of RSDB scheduling options may allocate an AP-related operation during a set time unit TU of a preset channel.

FIG. 11 is a view illustrating a structure of an electronic device according to an embodiment of the disclosure. The electronic device (receiver) of FIG. 11 may be implemented as an electronic device or Wi-Fi Aware device performing a receiver role illustrated in FIG. 3 to FIG. 9.

Referring to FIG. 11, the electronic device may include a transceiver 1110, a controller 1130, and a storage unit 1120. In the disclosure, the controller may be defined as a circuit, an application-specific integrated circuit, or at least one processor.

The transceiver 1110 may transmit and receive a signal to and from an external electronic device.

The controller 1130 may control the overall operation of the electronic device according to an embodiment. For example, the controller 1130 may control inter-block signal flow to perform the operations according to the above-described flowchart. Specifically, a controller 1130 may control, e.g., operations of the electronic device (receiver) illustrated in FIG. 3 to FIG. 9.

The storage unit 1120 may store at least one of information transmitted/received via the transceiver 1110 and information generated via the controller 1130.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present disclosure have been described above, various changes may be made thereto without departing from the scope of the present disclosure. Thus, the scope of the disclosure should not be limited to the above-described embodiments, and should rather be defined by the following claims and equivalents thereof.

1. A method of operating an electronic device performing Wi-Fi Aware communication, the method comprising:
transmitting a Bluetooth low energy (BLE) advertisement message and activating a Wi-Fi Aware module of the electronic device;
identifying whether a real-time simultaneous dual band (RSDB) function is available;
based on the RSDB function being available as a result of the identifying, selecting one RSDB scheduling option from among a plurality of RSDB scheduling options based on whether there is an access point (AP) connection of the electronic device and AP traffic characteristics; and
performing a discovery procedure according to the selected RSDB scheduling option.

2. The method of claim 1, further comprising, if the RSDB function is not available as a result of the identifying, performing the discovery procedure according to a Non-RSDB scheduling option.

3. The method of claim 1, further comprising, based on the AP connection not being present, selecting a first RSDB scheduling option from among the plurality of RSDB scheduling options.

4. The method of claim 1, further comprising, based on the AP connection being present and the AP traffic not being sensitive to delay and an amount of the AP traffic being less than a threshold, selecting a second RSDB scheduling option from among the plurality of RSDB scheduling options.

5. The method of claim 1, further comprising, based on the AP connection being present and the AP traffic being sensitive to delay, selecting a third RSDB scheduling option from among the plurality of RSDB scheduling options.

6. The method of claim 1, further comprising, based on the AP connection being present and an amount of the AP traffic being equal to or greater than a threshold, selecting a fourth RSDB scheduling option from among the plurality of RSDB scheduling options.

7. The method of claim 1, further comprising adjusting at least one of a channel and a time allocation ratio for each band according to the selected RSDB scheduling option.

8. The method of claim 1, further comprising:
obtaining information about Wi-Fi Aware from firmware or a framework in the electronic device; or
obtaining information about the AP traffic from the firmware or the framework in the electronic device.

9. The method of claim 1, wherein the discovery procedure includes an unsynchronized service discovery (USD) operation.

10. The method of claim 1, wherein some options among the plurality of RSDB scheduling options allocate an AP-related operation during a set time unit (TU) of a preset channel.

11. An electronic device performing Wi-Fi Aware communication, the electronic device comprising:
a transceiver; and
a controller, wherein the controller is configured to:
transmit a Bluetooth low energy (BLE) advertisement message and activates a Wi-Fi Aware module of the electronic device,
identify whether a real-time simultaneous dual band (RSDB) function is available,
based on the RSDB function being available as a result of the identifying, select one RSDB scheduling option from among a plurality of RSDB scheduling options based on whether there is an access point (AP) connection of the electronic device and AP traffic characteristics, and
perform a discovery procedure according to the selected RSDB scheduling option.

12. The electronic device of claim 11, wherein the controller is configured to, based on the RSDB function not being available as a result of the identifying, perform the discovery procedure according to a Non-RSDB scheduling option.

13. The electronic device of claim 11, wherein the controller is configured to, based on the AP connection not being present, select a first RSDB scheduling option from among the plurality of RSDB scheduling options.

14. The electronic device of claim 11, wherein the controller is configured to, based on the AP connection being present and the AP traffic not being sensitive to delay and an amount of the AP traffic being less than a threshold, select a second RSDB scheduling option from among the plurality of RSDB scheduling options.

15. The electronic device of claim 11, wherein the controller is configured to, based on the AP connection being present and the AP traffic being sensitive to delay, select a third RSDB scheduling option from among the plurality of RSDB scheduling options.
